(19) United States
(12) Patent Application Publication
(10) Pub. No.: US 2018/0009547 A1
(43) Pub. Date: Jan. 11, 2018

(54) Laser Projected Engine Hazard Zone Systems And Methods

(71) Applicant: The Boeing Company, Chicago, IL (US)

(72) Inventor: Ethan J. Brewer, Lake Stevens, WA (US)

(21) Appl. No.: 15/202,640

(22) Filed: Jul. 6, 2016

(51) Int. Cl. B64D 47/02; B64D 29/00; B64D 33/02; B64D 33/04

(52) U.S. Cl. CPC B64D 47/02; B64D 33/04; B64D 29/00; B64D 33/02

(57) ABSTRACT

An aircraft engine hazard zone projection system is described that includes an engine having an engine inlet and an engine outlet, and engine housing, and a light-emitting system connected to the engine housing. The light-emitting system is configured to project light on a ground below the engine housing so as to form at least one predetermined hazard zone surrounding the engine. The at least one predetermined hazard zone identifies at least one of an area subject to an engine inlet suction force or an area subject to an engine outlet exhaust force.

### FIELD

The present disclosure generally relates to hazard zones surrounding an aircraft engine, and more particularly to, methods and systems to visually represent one or more hazard zones surrounding an aircraft engine.

### BACKGROUND

Airline and airport employees work around commercial airlines every day throughout the world without incident. However, during operation, aircraft engines may create areas surrounding the engines that are hazardous to crew members and objects in close proximity to the engines. In particular, an area surrounding an engine inlet may be subject to an engine inlet suction force and an area surrounding an engine outlet may be subject to an engine outlet exhaust force. Objects within the area surrounding the engine inlet subject to the engine inlet suction force are at risk of being ingested into the engine. Further, objects within the area surrounding the engine outlet are at risk of encountering both extreme exhaust force and heat. Failure to observe proper safety and precautions, such as awareness of the hazard areas surrounding an aircraft engine, can result in serious injury or death as well as damage to both equipment and the engine.

Current methods of identifying the hazard zones surrounding an engine include providing graphical representations of the hazard zones. For instance, engine inlet and outlet hazard zones are typically described in a maintenance manual for the aircraft engine. Additionally, a warning sign including a graphical representation of the engine inlet and outlet hazard zones is often applied to the engine housing of the engine. However, an example drawback of these current methods of identifying the hazard zones is that these methods result in crew members estimating distances and/or angles in order to remain outside the hazard zones graphically represented in the maintenance manual and on the engine housing.

Some airline operators mark hazard zones on the ground by painting hazard zones on ramp surfaces at parking locations for aircrafts. However, a drawback of this approach is that such markings on the ground require that an aircraft be positioned correctly in relation to the markings in order to ensure that the painted markings appropriately identify the hazard zones. Another drawback of this approach is that parking locations may be used for different aircraft and these different aircraft may have different hazard-zone locations and size. Yet another drawback is that such markings on the ground are stationary and do not identify the hazard zones when the plane is on the ground at locations other than the parking location, such as when the aircraft is taxiing to the runway or holding on the ground. Still yet another drawback of this approach is that hazard zones change with engine power setting, and this change may not always be represented in ground markings.

What is needed is a system for providing on the ground visual representations of the hazard zones surrounding the engine that appropriately identify the hazard zones surrounding the engine regardless of the location of the aircraft on the ground or engine power setting.

### SUMMARY

In one example, an aircraft engine hazard zone projection system is described that includes an engine having an engine inlet and an engine outlet, an engine housing, and a light-emitting system connected to the engine housing. The light-emitting system is configured to project light on a ground below the engine housing so as to form at least one predetermined hazard zone surrounding the engine. The at least one predetermined hazard zone identifies at least one of an area subject to an engine inlet suction force or an area subject to an engine outlet exhaust force.

In another example, an aircraft engine hazard zone projection system is described that includes an engine housing and a light-emitting system connected to the engine housing. The light-emitting system is configured to project light on a surface below the engine housing so as to form a predetermined hazard zone surrounding the engine housing.

In yet another example, a method for visually representing a hazard zone surrounding an aircraft engine is described. The method includes defining a hazard zone comprising an area subject to an engine inlet suction force of the aircraft engine or an engine outlet exhaust force of the aircraft engine. The method further includes projecting a visible-light boundary of the hazard zone on a surface below the aircraft engine.

The features, functions, and advantages that have been discussed can be achieved independently in various embodiments or may be combined in yet other embodiments further details of which can be seen with reference to the following description and drawings.

### BRIEF DESCRIPTION OF THE FIGURES

The novel features believed characteristic of the illustrative embodiments are set forth in the appended claims. The illustrative embodiments, however, as well as a preferred mode of use, further objectives and descriptions thereof, will best be understood by reference to the following detailed description of an illustrative embodiment of the present disclosure when read in conjunction with the accompanying drawings.

FIG. 1 illustrates an example aircraft that includes an example aircraft engine hazard zone projection system, according to an example embodiment.

FIG. 2 illustrates a side view of the example aircraft engine hazard zone projection system of FIG. 1, according to an example embodiment.

FIG. 3 illustrates a top view of the example aircraft engine hazard zone projection system of FIG. 1, according to an example embodiment.

FIG. 4 illustrates another top view of the example aircraft engine hazard zone projection system of FIG. 1, according to an example embodiment.

FIG. 5 illustrates an example engine outlet hazard zone, according to an example embodiment.

FIG. 6 illustrate example engine inlet hazard zones, according to an example embodiment.

FIG. 7 illustrate example engine outlet hazard zones, according to an example embodiment.

FIG. 8 illustrates a simplified block diagram of a light-emitting system operable in the example aircraft engine hazard zone projection system of FIG. 1, according to an example embodiment

FIG. 9 shows a flowchart of an example method for visually representing a hazard zone surrounding an aircraft engine, according to an example embodiment.

FIG. 10 shows a flowchart of an example method for use with the method in FIG. 9, according to an example embodiment.

FIG. 11 shows a flowchart of an example method for use with the method in FIG. 9, according to an example embodiment.

### DETAILED DESCRIPTION

Disclosed embodiments will now be described more fully hereinafter with reference to the accompanying drawings, in which some, but not all of the disclosed embodiments are shown. Indeed, several different embodiments may be described and should not be construed as limited to the embodiments set forth herein. Rather, these embodiments are described so that this disclosure will be thorough and complete and will fully convey the scope of the disclosure to those skilled in the art.

As mentioned above, current systems and methods for identifying hazard zones surrounding an engine have a number of drawbacks. For instance, existing methods of identifying the hazard zones via graphical representation in a maintenance manual and on an engine housing result in crew members estimating distances and/or angles of the hazard zones in order to remain outside the hazard zones. Further, existing methods of identifying the hazard zones via markings on the ground require that the aircraft be positioned correctly in relation to the markings, in order to ensure that the markings appropriately identify the hazard zones. The methods and systems in accordance with the present disclosure beneficially provide improved methods and systems for visually representing one or more hazard zones surrounding an aircraft engine on a surface below the aircraft engine.

In one example, an aircraft engine hazard zone projection system is described that includes an engine having an engine inlet and an engine outlet, an engine housing, and a light-emitting system connected to the engine housing. The light-emitting system is configured to project light on a ground below the engine housing so as to form at least one predetermined hazard zone surrounding the engine. The at least one predetermined hazard zone identifies at least one of an area subject to an engine inlet suction force or an area subject to an engine outlet exhaust force. This aircraft engine hazard zone projection system beneficially provides on the ground clear visual representations of the hazard zones that appropriately identify the hazard zones regardless of the location of the aircraft on the ground.

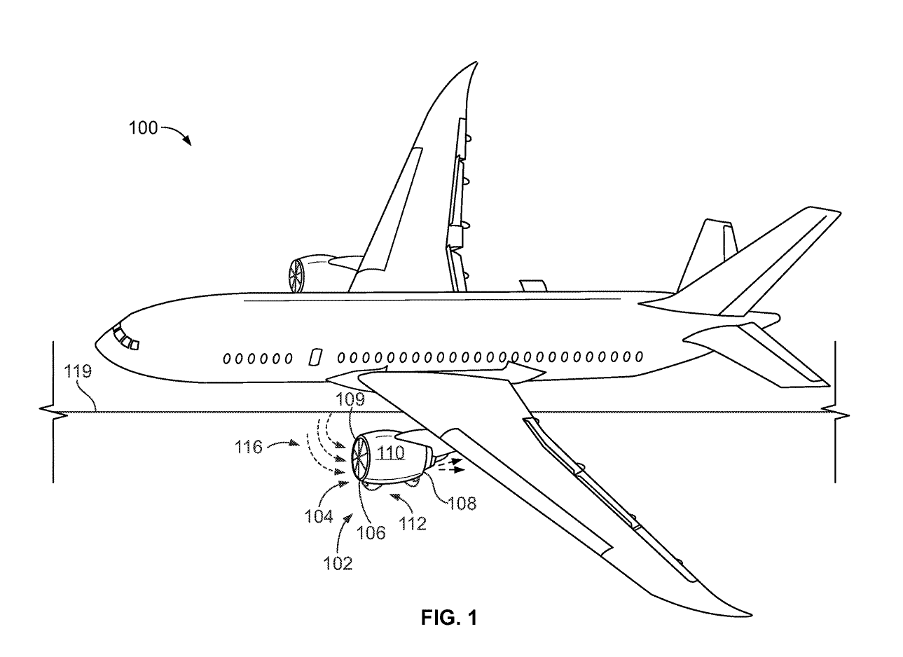

Referring now to FIG. 1, an example aircraft 100 is illustrated that includes an example aircraft engine hazard zone projection system 102. The system 102 includes an engine 104 having an engine inlet 106 and an engine outlet 108. The engine 104 includes a fan 109. The system 102 also includes an engine housing 110 that houses the engine 104. Further, the system 102 includes a light-emitting system 112 connected to the engine housing 110 and configured to project light on a surface below the engine 104.

During operation, the engine 104 may create hazardous areas surrounding the engine 104. In particular, during operation, an area surrounding the engine inlet 106 is subject to an engine inlet suction force 116 and an area surrounding the engine outlet 108 is subject to an engine outlet exhaust force 118. When the aircraft 100 is positioned on a surface such as ground 119 (e.g., when the aircraft is located at the gate or hangar, during push-back, during taxiing, etc.), crew members on the ground 119 may be in close proximity to the engine 104. Additionally, there may also be equipment on the ground 119 in close proximity to the engine 104. These areas surrounding the engine inlet 106 and engine outlet 108 may be hazardous to both crew members and equipment, and thus it is important that crew members and equipment remain outside of these areas surrounding the engine inlet 106 and surrounding the engine outlet 108.

In order to clearly identify these hazardous areas on the ground 119 near the engine 104, the light-emitting system 112 is configured to project light on the ground 119 below the engine housing so as to form (i) a predetermined hazard zone that identifies the area subject to the engine inlet suction force 116 and/or (ii) a predetermined hazard zone that identifies the area subject to the engine outlet exhaust force 118.

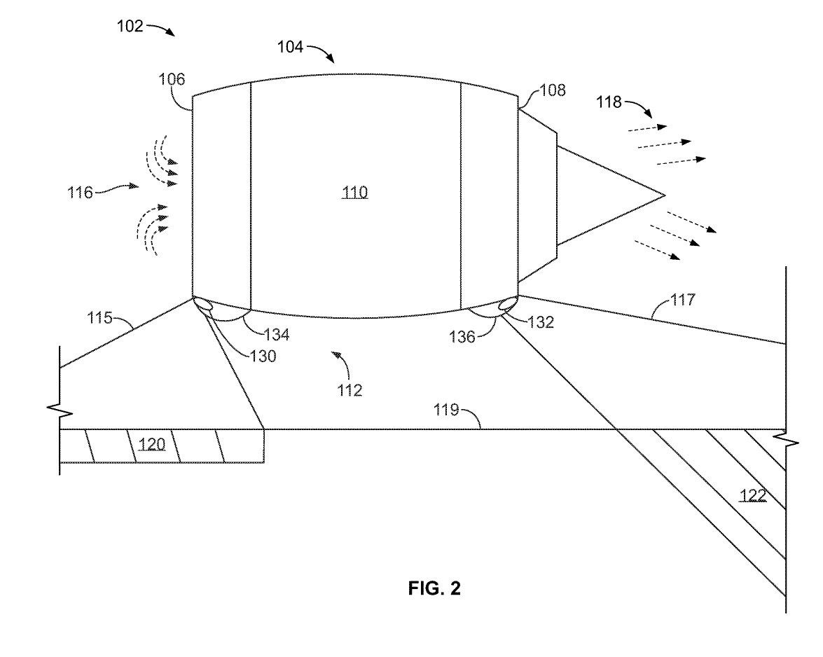

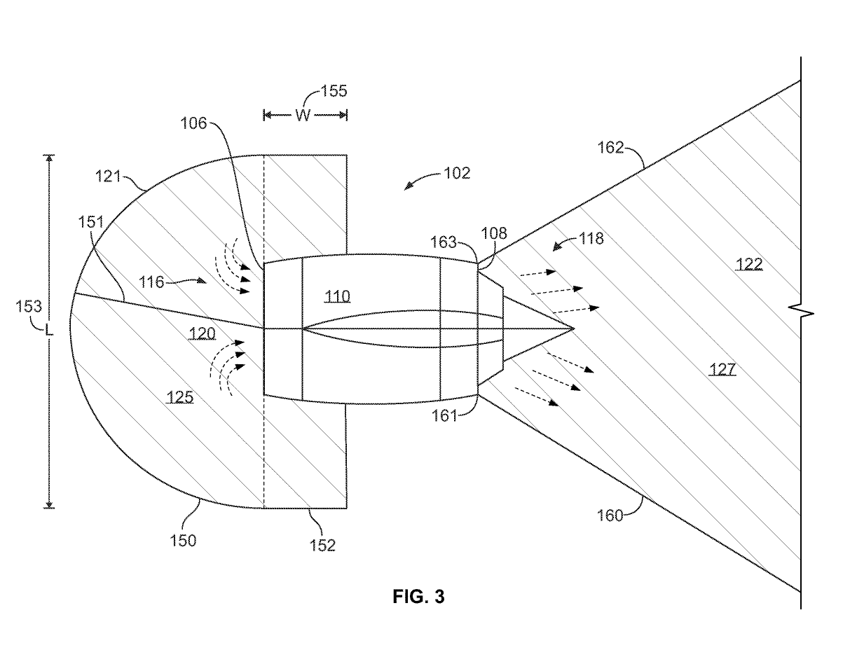

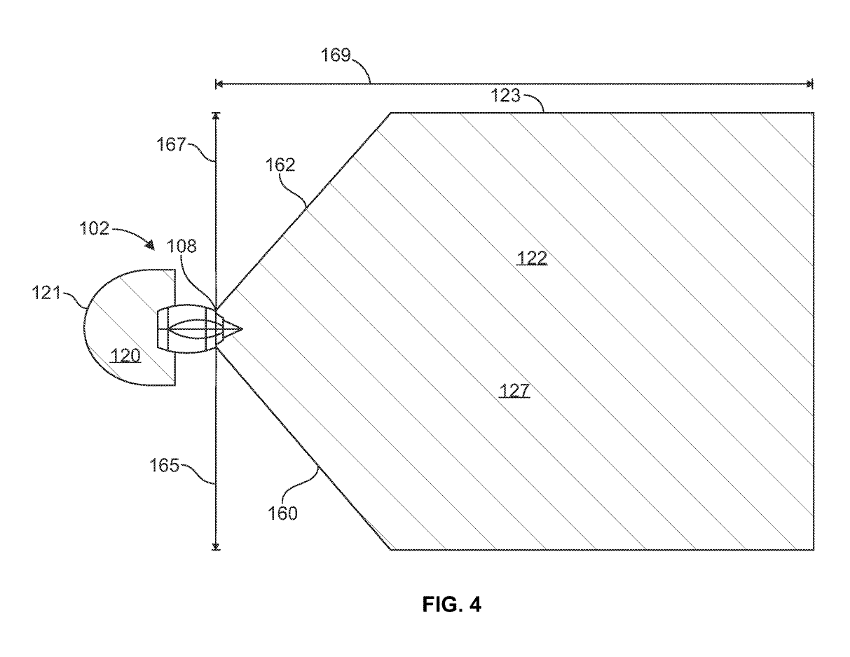

Example predetermined hazard zones are depicted in FIGS. 2-4. FIG. 2 depicts a side view of the aircraft engine hazard zone projection system 102, whereas FIGS. 3 and 4 depict top views of the aircraft engine hazard zone projection system 102. For clarity, these side and top views depict the aircraft engine hazard zone projection system 102 and not the other portions of aircraft 100, such as the wings and main body.

As seen in FIG. 2, the light-emitting system 112 projects light 115 on the ground 119, so as to form predetermined hazard zone 120. Predetermined hazard zone 120 identifies the area subject to the engine inlet suction force 116. Further, the light-emitting system 112 projects light 117 on the ground 119, so as to form predetermined hazard zone 122. Predetermined hazard zone 122 identifies the area subject to engine outlet exhaust force 118.

The predetermined hazard zone 120 surrounding the engine inlet 106 may be any suitable shape and size to identify the area subject to engine inlet suction force 116. Typically, the hazard zone surrounding an engine inlet such as engine inlet 106 extends both in front of the engine inlet and behind the engine inlet. For instance, with reference to FIG. 3, predetermined hazard zone 120 includes a first portion 150 extending in front of the engine inlet 106 and a second portion 152 extending behind the engine inlet 106. In the example of FIG. 3, first portion 150 is a semi-circular area or substantially semi-circular area adjacent to the engine inlet 106 and second portion 152 is a rectangular area or a substantially rectangular area behind the engine inlet 106.

By the term “substantially” it is meant that the recited characteristic need not be achieved exactly, but that deviations or variations, including for example, tolerances, measurement error, measurement accuracy limitations and other factors known to skill in the art, may occur in amounts that do not preclude the effect the characteristic was intended to provide.

In an example embodiment, the substantially semi-circular area adjacent to the engine inlet 106 has a radius 151 of approximately 10 feet or more. However, in other examples, the radius 151 may be less than approximately 10 feet. For instance, in another example, the substantially semi-circular area adjacent to the engine inlet 106 has a radius between approximately 6 and 10 feet. Other examples are possible as well.

The second portion 152 covers an area behind the engine inlet 106 that is also subject to the engine inlet suction force 116. In an example embodiment, the length 153 of the second portion corresponds to the diameter of the first portion 150, and the width 155 of the second portion is approximately 5 feet or more. However, in other examples, the width 155 may be less than approximately 5 feet. For instance, in another example, the width 155 is between approximately 3 and 5 feet. Other examples are possible as well.

The predetermined hazard zone 122 surrounding the engine outlet 108 may be any suitable shape and size to identify an area subject to engine exhaust forces. Typically, the hazard zone surrounding an engine outlet such as engine outlet 108 extends a given distance both longitudinally and laterally behind the engine outlet. For instance, the hazard zone surrounding an engine outlet 108 typically extends from the both sides of the engine outlet at a given angle up to a given lateral distance from the engine outlet, and the hazard zone also typically extends a given distance longitudinally behind the engine outlet. In an example, the given angle is approximately 45 degrees. However, the given angle may be more or less than approximately 45 degrees. For instance, in an example, the given angle may be between approximately 30 and 60 degrees.

With reference to FIGS. 3-4, the predetermined hazard zone 122 includes an area behind a first line 160 extending from a first side 161 of the engine outlet 108 at an approximately 45 degree angle up to a lateral distance 165 (see FIG. 4) from the engine outlet 108. The predetermined hazard zone 122 also comprises an area behind a second line 162 extending from a second side 163 of the engine outlet 108 at an approximately 45 degree angle up to a lateral distance 167 from the engine outlet. The hazard zone 122 then continues extending longitudinally behind the engine outlet up to a longitudinal distance 169 (see FIG. 4). In an example embodiment, the lateral distances 165 and 167 are between approximately 50 and 75 feet, and the longitudinal distance 169 is approximately 400 to 500 feet. Other example angles and distances are possible as well.

By the term “approximately” it is meant that the recited parameter or value need not be achieved exactly, but that deviations or variations, including for example, tolerances, measurement error, measurement accuracy limitations and other factors known to skill in the art, may occur in amounts that do not preclude the effect the parameter or value was intended to provide. As used herein, “approximately X degrees” means any degree in the range of X degrees +/−0.1*(X degrees). Further, as used herein, “approximately X feet” means any distance in the range of X feet +/−0.1*(X feet).

Projecting light 115 and 117 on the ground 119 below the engine housing 110 so as to form predetermined hazard zone 120 and the predetermined hazard zone 122 may take various forms. In general, the light-emitting system 112 may be configured to project light 115 and 117 in any suitable way to clearly identify to crew members areas surrounding the engine that a crew member should avoid.

In an example embodiment, the light-emitting system 112 is configured to project a visible-light boundary of the entire hazard zone 120 and a visible-light boundary of the entire hazard zone 122. For instance, as shown in FIGS. 3 and 4, light-emitting system 112 projects light 115 to form boundary 121 for predetermined hazard zone 120, and the light-emitting system 112 projects light 117 to form boundary 123 (see FIG. 4) for predetermined hazard zone 122.

In addition to being configured to project the boundaries 121 and 123, the light-emitting system 112 may also be configured to project light over the area within the boundaries 121 and 123. For example, the area within the predetermined hazard zone 120 or 122 may be filled with projected light. For instance, as shown in FIG. 2, light-emitting system 112 projects light to fill the area 125 within boundary 121 and light-emitting system 112 projects light to fill the area 127 within boundary 123. Such fill light may serve to make the predetermined hazard zones 120 and 122 even more conspicuous.

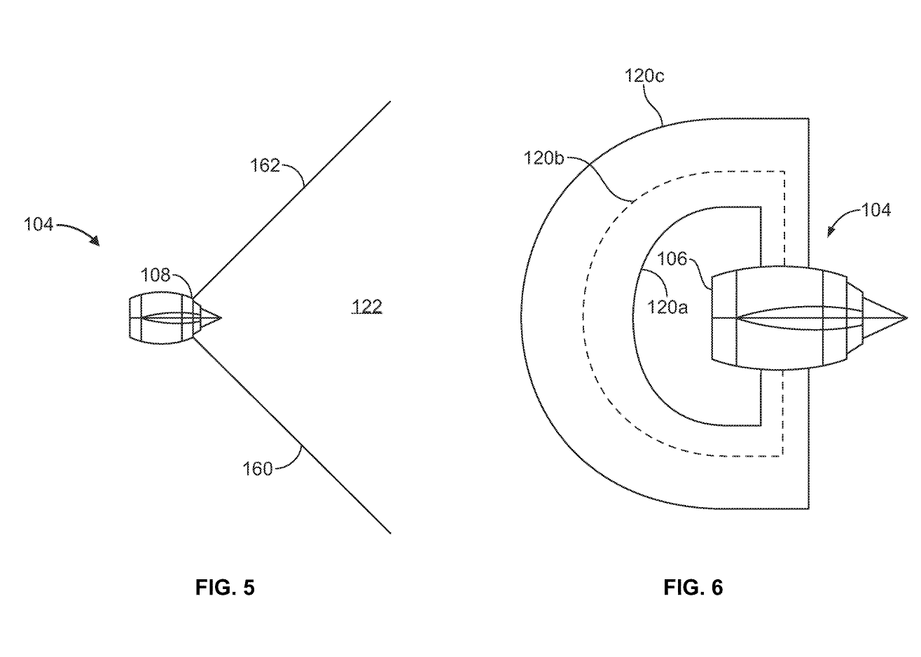

In another example embodiment, rather than the light-emitting system 112 projecting a visible-light boundary of the entire hazard zone 120 or 122, the light-emitting system 112 may be configured to project a visible-light boundary of a portion of the hazard zone 120 or 122. For instance, FIG. 5 illustrates an example embodiment where light-emitting system 112 projects light to form a boundary of a portion of hazard zone 122. In particular, FIG. 5 illustrates an embodiment where light-emitting system 112 projects boundary lines 160 and 162 in order to form the hazard zone 122. In this embodiment of FIG. 5, crew members operating around the engine 104 could be instructed that the hazard area 122 is any area behind the boundary lines 160 and 162. Crew members would thus be aware that the crew members should avoid crossing beyond boundary lines 160 and 162 in order to avoid the hazard area 122 behind the engine outlet 108.

It should be understood that the shapes and sizes of predetermined hazard zones 120 and 122 depicted in FIGS. 2-5 are intended as examples only. Other shapes and sizes of the predetermined hazard zones are possible as well. The shape and size of the predetermined hazard zones may depend on various factors, such as the size and/or the type of aircraft engine. Further, aircraft engine maintenance manuals typically describe engine inlet hazard areas and exhaust hazard areas for the particular engine associated with the maintenance manual. The predetermined hazard zones 120 and 122 may correspond to or substantially correspond to the hazard areas defined in the maintenance manual associated with engine 104.

Additionally, although in the example of FIGS. 2-4 the light-emitting system 112 projects light to form both predetermined hazard zone 120 and predetermined hazard zone 122, in another example embodiment, the light-emitting system 112 is configured to form one of predetermined hazard zone 120 and predetermined hazard zone 122.

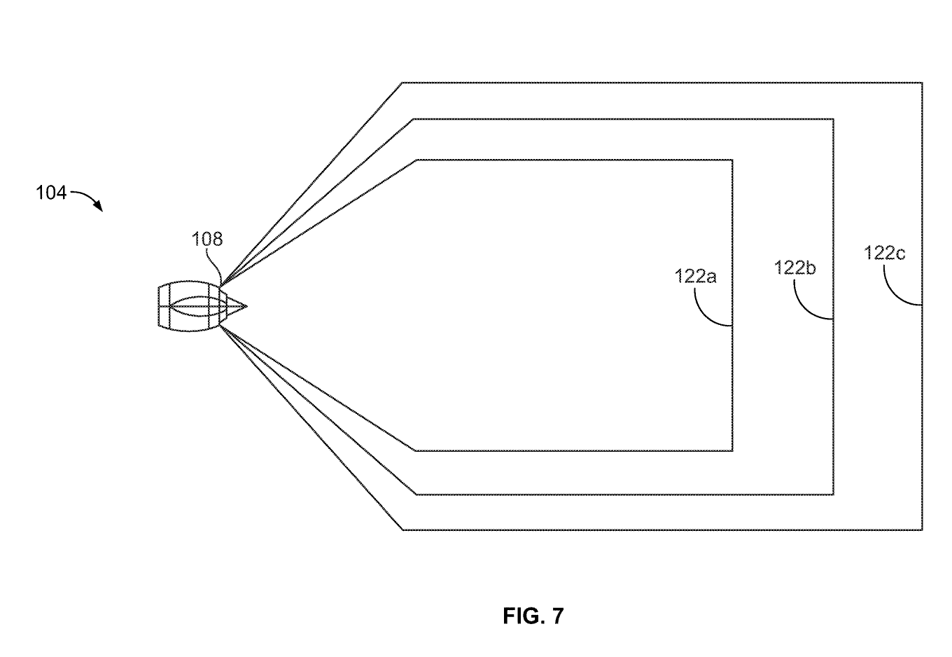

During operation of the engine 104, the size of the area surrounding the engine inlet 106 subject to an engine inlet suction force 116 and the size of the area surrounding the engine outlet 108 subject engine outlet exhaust force 118 may vary based on a stage of operation of the engine. Therefore, in an example embodiment, the light-emitting system 112 is configured to adjust a size of the hazard zones based on a stage of operation of the engine. FIGS. 6 and 7 illustrate an example embodiment where the light-emitting system 112 adjusts a size of the hazard zones 120 and 122 based on a stage of operation of the engine 104. In particular, FIG. 6 illustrates hazard zone 120a at a first stage of operation, hazard zone 120b at a second stage of operation, and hazard zone 120c at a third stage of operation of the engine. Further, FIG. 7 illustrates hazard zone 122a at a first stage of operation, hazard zone 122b at a second stage of operation, and hazard zone 122c at a third stage of operation of the engine. In an example embodiment, the first stage of operation corresponds to idle power, the second stage of operation corresponds to breakaway power, and the third stage of operation corresponds to takeoff power. Other stages of operation of the engine are possible as well.

In another example embodiment, the light-emitting system 112 is configured to adjust a size of the predetermined hazard zones 120 and 122 based on a fan speed of fan 109 (see FIG. 1). In an example embodiment, the size of the predetermined hazard zones 120 and 122 increases as the fan speed of increases.

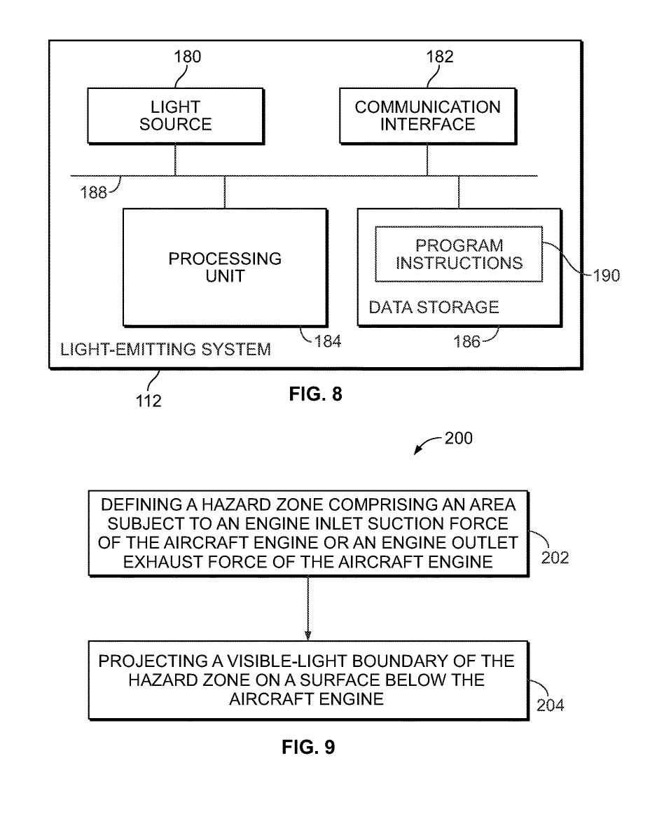

FIG. 8 is next a simplified block diagram of light-emitting system 112 showing some of the physical components that such a light-emitting system may include. As shown in FIG. 8, the light-emitting system 112 includes light source 180, a communications interface 182, a processing unit 184, and data storage 186, all of which may be communicatively linked together by a system bus, network, or other connection mechanism 188.

With this example arrangement, the communication interface 182 functions to provide for communication with various other aircraft elements (e.g., an aircraft control system) and may thus take various forms, allowing for wired and/or wireless communication for instance. Processing unit 184 comprises one or more general purpose processors (e.g., microprocessors) and/or one or more special purpose processors (e.g., application specific integrated circuits) and may be integrated in whole or in part with the communication interface. And data storage 186 comprises one or more volatile and/or non-volatile storage components, such as optical, magnetic, or flash memory and may be integrated in whole or in part with the processing unit. As shown, by way of example, data storage 186 includes non-transitory computer readable medium and stores program instructions 190, which are executable by processing unit 184 to carry out various functions described herein.

In an example embodiment, program instructions 190 are executable to perform functions comprising: (i) defining a hazard zone comprising an area subject to an engine inlet suction force of the aircraft engine or an engine outlet exhaust force of the aircraft engine; and (ii) projecting a visible-light boundary of the hazard zone on a surface below the aircraft engine.

Light source 180 may include one or more emitters to form the predetermined hazard zones 120 and 122. For instance, in the example of FIG. 2, the light source of light-emitting system 112 includes a first emitter 130 configured to project light 115 to form the predetermined hazard zone 120 and a second emitter 132 configured to project light 117 to form the predetermined hazard zone 122. The emitters 130, 132 may be any suitable emitter to project visible light to form the predetermined hazard zones 120 and 122 on the ground 119 below the engine housing 110. Further, the emitters 130, 132 may project any suitable color to clearly identify the hazard zones on the ground. In an example embodiment, the emitters 130, 132 include a laser that emits red light. In another example embodiment, the emitters 130, 132 include a light-emitting diode (LED) projector that emits yellow light. Other light sources and colors are possible as well.

The light-emitting system 112 may also include an emitter window for enclosing the one or more emitters. As seen in the example of FIG. 2, emitter 130 is enclosed in an emitter window 134 and emitter 132 is enclosed in emitter window 136. In an example, the emitter windows 134, 136 protrude from the engine housing 110 and the shape of the emitter windows 134, 136 are selected based on aerodynamic properties. In general, the shape of the emitter windows 134, 136 are selected so as to reduce or eliminate drag. In an example, the emitter windows 134, 136 comprise a curved shape, such as a tear-drop shape. In another example, the emitter windows 134, 136 are flush with the engine housing 110. Other shapes of the emitter windows 134, 136 are possible as well.

The light-emitting system 112 may be mounted at any suitable location on the engine housing 112. For instance, as shown in FIG. 2, the light-emitting system 112 is mounted on and underside of the engine housing 110. In other example embodiments, the light-emitting system 112 or portions of the light-emitting system 112 may be mounted at other locations on the aircraft 100. For example, the light-emitting system 112 or a portion of light-emitting system 112 (e.g., one or more emitters) could be positioned on the main body of the aircraft 100, a wing of the aircraft 100, a tail of the aircraft 100, or on another suitable location on the aircraft 100.

FIG. 9 shows a flowchart of an example method 200 for visually representing a hazard zone surrounding an aircraft engine, according to an example embodiment. Method 200 shown in FIG. 9 presents an embodiment of a method that, for example, could be used with the aircraft engine hazard zone projection system 102 shown in FIG. 1, for example. It should be understood that for this and other processes and methods disclosed herein, flowcharts show functionality and operation of one possible implementation of present embodiments. Alternative implementations are included within the scope of the example embodiments of the present disclosure in which functions may be executed out of order from that shown or discussed, including substantially concurrent or in reverse order, depending on the functionality involved, as would be understood by those reasonably skilled in the art.

At block 202, the method 200 includes defining a hazard zone comprising an area subject to an engine inlet suction force of the aircraft engine or an engine outlet exhaust force of the aircraft engine. In an example embodiment, the method includes defining hazard zone 120 comprising an area subject to the engine inlet suction force 116 of the aircraft engine 104. In another example embodiment, the method 200 includes defining hazard zone 122 comprising the engine outlet exhaust force 118 of the aircraft engine 104. In yet another example embodiment, defining the hazard zone includes defining a size of the hazard zone based on a stage of operation of the aircraft engine.

At block 204, the method 200 includes projecting a visible-light boundary of the hazard zone on a surface below the aircraft engine. In an example where the defined hazard zone comprises the area subject to an engine inlet suction force 116, projecting the visible-light boundary includes projecting visible-light boundary 121 of hazard zone 120 on ground 119, as seen in FIG. 3. In an example where the defined hazard zone comprises an area subject to the engine outlet exhaust force 118, projecting the visible-light boundary includes projecting visible-light boundary 123 of hazard zone 122 on ground 119, as shown in FIG. 4. In another example, projecting the visible-light boundary includes projecting line 160 and line 162, as shown in FIG. 5.

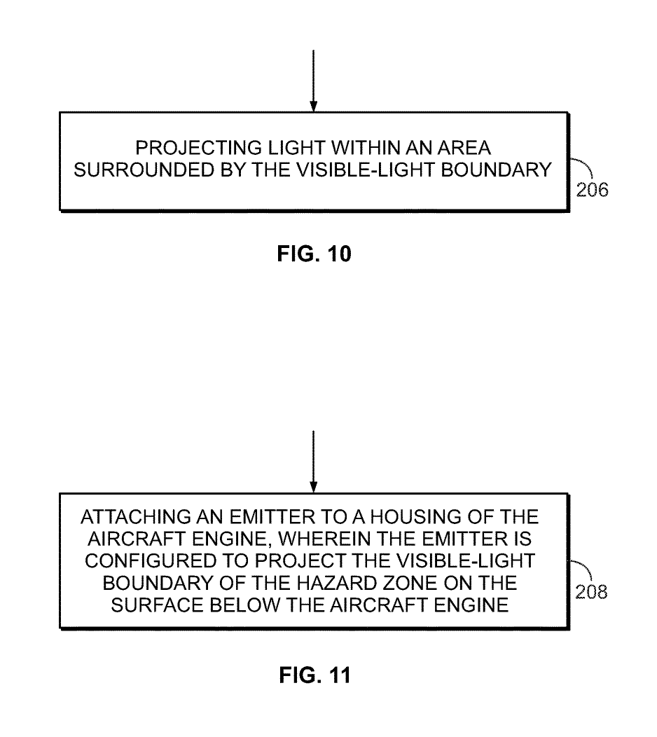

FIG. 10 shows a flowchart of an example method for use with the method 200, according to an example embodiment. At block 206, functions include projecting light within an area surrounded by the visible-light boundary. FIG. 11 shows a flowchart of an example method for use with the method 200, according to an example embodiment. At block 208, functions include attaching an emitter to a housing of the aircraft engine, wherein the emitter is configured to project the visible-light boundary of the hazard zone on the surface below the aircraft engine. In an example, an existing aircraft engine may be retrofitted to include light-emitting system 112. In another example, light-emitting system 112 may be attached to the engine housing during manufacturing or assembly of the aircraft engine.

Example aircraft engine hazard zone projection systems and methods described herein are a low-cost solution to consistently and clearly indicate hazard zones surrounding an aircraft engine. The disclosed methods and systems beneficially provide a visual representation of a hazard zone on the ground below the engine regardless of the location of the aircraft on the ground. The described systems and methods also beneficially reduce or eliminate a need for crew members to estimate distances and/or angles of the hazard zones when the crew members are located near an operating engine. Thus, the described methods and systems can help to improve safety of crew members that are working near an operating aircraft engine. The described systems and methods may also reduce or eliminate incidents of economic damage to equipment and/or an engine, such as damage to equipment or the engine resulting from equipment subject to the inlet suction force being ingested into the engine.

Although the disclosed systems and methods are described with reference to aircraft engines, it should be understood that disclosed systems and methods may be implemented in other systems as well. For instance, the disclosed systems and methods may be implemented for engines used in other industries, such as the automotive industry, the construction industry, or the agricultural industry. Other examples are possible as well.

The description of the different advantageous arrangements has been presented for purposes of illustration and description, and is not intended to be exhaustive or limited to the embodiments in the form disclosed. Many modifications and variations will be apparent to those of ordinary skill in the art. Further, different advantageous embodiments may describe different advantages as compared to other advantageous embodiments. The embodiment or embodiments selected are chosen and described in order to explain the principles of the embodiments, the practical application, and to enable others of ordinary skill in the art to understand the disclosure for various embodiments with various modifications as are suited to the particular use contemplated.

1. An aircraft engine hazard zone projection system, the system comprising:
an engine having an engine inlet and an engine outlet;
an engine housing; and
a light-emitting system connected to the engine housing and configured to project light on a ground below the engine housing so as to form at least one predetermined hazard zone surrounding the engine, wherein the at least one predetermined hazard zone identifies at least one of an area subject to an engine inlet suction force or an area subject to an engine outlet exhaust force, wherein the light-emitting system is mounted on an underside of the engine housing and comprises an emitter and an emitter window, wherein the emitter window protrudes from the engine housing, and wherein a shape of the emitter window comprises a tear-drop shape.

2. The system of claim 1, wherein the light-emitting system is further configured to adjust a size of the at least one predetermined hazard zone based on a stage of operation of the engine.

3. The system of claim 1, wherein the engine comprises a fan, and wherein the light-emitting system is further configured to adjust a size of the at least one predetermined hazard zone based on a fan speed.

4. The system of claim 1, wherein the shape of the emitter window is selected based on aerodynamic properties.

5. The system of claim 1, wherein the at least one predetermined hazard zone surrounding the engine comprises (i) a predetermined hazard zone surrounding the engine inlet that identifies the area subject to the engine inlet suction force and (ii) a predetermined hazard zone surrounding the engine outlet that identifies the area subject to the engine outlet exhaust force.

6. The system of claim 5, wherein the light-emitting system further comprises a second emitter, wherein the emitter is configured to project the predetermined hazard zone surrounding the engine inlet, and wherein the second emitter is configured to project the predetermined hazard zone surrounding the engine outlet.

7. The system of claim 1, wherein the light-emitting system is configured to form a boundary for each respective zone of the at least one predetermined hazard zone.

8. The system of claim 7, wherein the boundary for each respective zone surrounds an area, and wherein the light-emitting system is further configured to project light over the area within the boundary.

9. The system of claim 1, wherein the at least one predetermined hazard zone surrounding the engine comprises a predetermined hazard zone surrounding the engine inlet that identifies the area subject to the engine inlet suction force, wherein the predetermined hazard zone surrounding the engine inlet comprises a substantially semi-circular area adjacent to the engine inlet.

10. The system of claim 9, wherein the substantially semi-circular area has a radius of at least ten feet.

11. The system of claim 1, wherein the at least one predetermined hazard zone surrounding the engine comprises a predetermined hazard zone surrounding the engine outlet that identifies the area subject to the engine outlet exhaust force, wherein the predetermined hazard zone surrounding the engine outlet comprises a first line extending from a first side of the engine outlet at an approximately 45 degree angle and a second line extending from a second side of the engine outlet at an approximately 45 degree angle.

12. An aircraft engine hazard zone projection system, the system comprising:
an engine housing; and
a light-emitting system connected to the engine housing, wherein the light-emitting system is configured to project light on a surface below the engine housing so as to form a predetermined hazard zone surrounding the engine housing, wherein the light-emitting system is mounted on an underside of the engine housing and comprises an emitter and an emitter window, wherein the emitter window protrudes from the engine housing, and wherein a shape of the emitter window comprises a tear-drop shape.

13. The system of claim 12, further comprising an engine, wherein the light-emitting system is further configured to adjust a size of the predetermined hazard zone based on a stage of operation of the engine.

14. The system of claim 12, further comprising an engine having an engine inlet and an engine outlet, wherein the predetermined hazard zone surrounding the engine housing comprises an area subject to an engine inlet suction force or an area subject to an engine outlet exhaust force.

15. A method for visually representing a hazard zone surrounding an aircraft engine, the method comprising:
defining a hazard zone comprising an area subject to an engine inlet suction force of the aircraft engine or an engine outlet exhaust force of the aircraft engine;
projecting a visible-light boundary of the hazard zone on a surface below the aircraft engine; and
attaching a light-emitting system to an underside of an engine housing of the aircraft engine, wherein the light-emitting system is configured to project the visible-light boundary of the hazard zone on the surface below the aircraft engine, wherein the light-emitting system comprises an emitter and an emitter window, wherein the emitter window protrudes from the engine housing, and wherein a shape of the emitter window comprises a tear-drop shape.

16. The method of claim 15, wherein the method further comprises projecting light within an area surrounded by the visible-light boundary.

17. The method of claim 15, wherein projecting a visible-light boundary of the hazard zone on a surface below the aircraft engine comprises projecting a substantially semi-circular boundary in front of an engine inlet of the aircraft engine.

18. The method of claim 15, wherein projecting a visible-light boundary of the hazard zone on a surface below the aircraft engine comprises projecting a first line extending from a first side of the engine outlet at approximately a 45 degree angle and a second line extending from a second side of the engine outlet at approximately a 45 degree angle.

19. The method of claim 15, wherein defining the hazard zone comprises defining a size of the hazard zone based on a stage of operation of the aircraft engine.

20. The method of claim 15, wherein attaching a light-emitting system to an underside of an engine housing of the aircraft engine comprises retrofitting the aircraft engine to include the light-emitting system.
